(19) United States
(12) Patent Application Publication
(10) Pub. No.: US 2026/0155888 A1
(43) Pub. Date: Jun. 4, 2026

(54) APPARATUS AND METHODS FOR VERIFYING NETWORK CONTINUITY

(71) Applicant: AFL Telecommunications LLC, Duncan, SC (US)

(72) Inventors: Bin Liu, Chestnut Hill, MA (US); Michael Scholten, Westford, MA (US); Scott Prescott, Belmont, NH (US); Dale Eddy, Gilford, NH (US)

(21) Appl. No.: 19/123,261

(22) PCT Filed: Oct. 24, 2023
(86) PCT No.: PCT/US2023/035783

§ 371 Date: Apr. 22, 2025

Related U.S. Application Data
(60) Provisional application No. 63/418,771, filed on Oct. 24, 2022.
(60) Provisional application No. 63/541,478, filed on Sep. 29, 2023.

(51) Int. Cl. H04B 10/071

(52) U.S. Cl. CPC H04B 10/071

(57) ABSTRACT

Optical networks and methods associated with optical networks for verifying network continuity. A method for verifying network continuity includes providing a fiber Bragg grating (FBG) device at a cable associated with a network, wherein the FBG device is configured to reflect a λ₁ wavelength; sending an optical test signal into the cable from a location upstream of the FBG device, the optical test signal having a λ₁ wavelength; and detecting a reflected signal associated with the λ₁ wavelength to verify network connectivity to the FBG device and measure network insertion loss.

### CROSS-REFERENCE TO RELATED APPLICATIONS

The present application is a national stage entry of International Application No. PCT/US2023/035783, filed on Oct. 24, 2023, which claims priority to U.S. Provisional Application 63/418,771 filed on Oct. 24, 2022 and U.S. Provisional Application 63/541,478 filed on Sep. 29, 2023, the disclosures of which are all incorporated by reference herein in their entireties.

### FIELD

The present disclosure relates generally to methods and apparatus for verifying network continuity.

### BACKGROUND

Optical fiber networks are used to transmit data between two or more endpoints. Optical fiber networks are typically formed from a plurality of interconnected optical fiber cables. Optical signals can be sent between various locations along the optical fiber network through the plurality of optical fiber cables. Optical transmission requires continuous connectivity of the optical fiber network. Any break within the optical fiber network prevents signal transmission to at least one endpoint within the optical fiber network.

It is important to be able to quickly and easily identify where signal interruption occurs upon loss of signal to fix the interruption and restore the optical fiber network. Traditional systems and methods for identifying signal interruption rely on computational OTDR trace and event analysis. These techniques are not ideal for quickly checking network continuity in the field and provide less accurate assessment of network health, e.g., insertion loss. Moreover, these techniques require expensive and heavy equipment which constrains their functional use.

Accordingly, improved apparatus and methods for verifying optical network continuity and measuring network health are desired in the art. In particular, systems and methods which reduce continuity verification time and expense would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a method for verifying network continuity is provided. The method includes providing a fiber Bragg grating (FBG) device at a cable associated with a network, wherein the FBG device is configured to reflect a λ₁ wavelength; sending an optical test signal into the cable from a location upstream of the FBG device, the optical test signal having a λ₁ wavelength; and detecting a reflected signal associated with the λ₁ wavelength to verify network connectivity to the FBG device.

In accordance with another embodiment, an optical network architecture for verifying network continuity is provided. The optical network architecture includes a service provider central office that sends optical signals through a network; a plurality of cables associated with endpoints of the network; an optical fiber network optically coupling the service provider central office to the plurality of cables, wherein the optical fiber network comprises a splitter; and a plurality of fiber Bragg grating (FBG) devices each optically coupled to one of the plurality of cables.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a schematic view of a passive optical network (PON) in accordance with embodiments of the present disclosure;

FIG. 2 is a graphical view of a reflectance profile of a reflector in accordance with embodiments of the present disclosure;

FIG. 3A is a schematic view of a socket-plug-type reflector for use with an optical network unit in accordance with embodiments of the present disclosure;

FIG. 3B is a schematic view of a socket-plug-type reflector for use with an optical network unit in accordance with other embodiments of the present disclosure;

FIG. 4A is a schematic view of a cable-type reflector for use with an optical network unit in accordance with embodiments of the present disclosure;

FIG. 4B is a schematic view of a cable-type reflector for use with an optical network unit in accordance with other embodiments of the present disclosure;

FIG. 5 is a schematic view of a cassette-type reflector for use with an optical network unit in accordance with embodiments of the present disclosure;

FIG. 6 is a schematic view of a tester being used with a PON and a reflector in accordance with embodiments of the present disclosure;

FIG. 7 is a schematic view of the tester of FIG. 6 in accordance with embodiments of the present disclosure;

FIG. 8 is a schematic view of a tester being used with a PON and a reflector in accordance with embodiments of the present disclosure;

FIG. 9 is a schematic view of the tester of FIG. 8 in accordance with embodiments of the present disclosure;

FIG. 10 is a schematic view of a tester being used with a PON and a reflector in accordance with embodiments of the present disclosure; and

FIG. 11 is a schematic view of the tester of FIG. 10 in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, methods and apparatuses are described herein which provide effective verification of network connectivity. The methods and apparatuses described herein can utilize devices, such as fiber Bragg grating (FBG) devices, which reflect certain wavelengths of optical test signals. The signal characteristics of reflected wavelengths, such as signal intensity, frequency, etc., can be inspected to verify network connectivity and to troubleshoot network issues.

Referring now to the drawings, FIG. 1 illustrates a network in accordance with an exemplary embodiment. It should be understood that the illustrated network is merely provided for the purpose of example. The apparatuses, systems and methods described herein can be used with and employed in other types of optical networks.

The network illustrated in FIG. 1 is a passive optical network (PON) 100 which acts as a physical layer and infrastructure of a Fiber to the Home (FTTH) system linking an optical line terminal (OLT) 102 at a service provider's central office 104 to a number of optical network units (ONU) 106 at customer premises through a fiber optical distribution network (ODN) 108. The OLT 102 can provide data to the one or more ONUs 106 from one or more services such as, for example, corporate servers and storage devices, outside telecommunication connections like public switched telephone network (PSTN), community antenna television (CATV), internet protocol television (IPTV), video on demand (VOD), multiprotocol label switching (MPLS), or the like.

The ODN 108 can include one or more optical cables 110 configured to transmit optical signals through the ODN 108. The optical signals can be transmitted unidirectionally or bidirectionally between the OLT 102 and one or more of the ONUs 106. The fiber optic cable 110 can be branched, for example, at one or more distributor nodes 112 and one or more splitters 114 located at a demarcation point, to transmit signals to the ONUs 106 located at each of the customer premises. The ONUs 106 can receive the transmitted signals and provide broadband access to the customer. Similarly, return signals can originate at the ONUs 106 and be transmitted through the ODN 108 to the OLT 102.

The fiber optic cables 110 can be branched throughout the ODN, e.g., at the splitters 114 to serve a wide range of customers. A primary cable 110 can branch into a plurality of cables at the distributor nodes 112. The plurality of cables can then each be branched by the splitters 114 into separate drop cables 116. These drop cables 116 can further be branched as required and each individual cable can enter a customer's premises. Using the drop cable 116, or another intermediary cable, the customer can then couple the ONU 106 to the ODN 108 and have access to the OLT 102.

Signals from the OLT 102 to an individual ONU 106 are only possible if the ODN 108, and more particularly the portion of the ODN 108 extending between the OLT 102 and that particular ONU 106, are continuous and uninterrupted. Any interruptions or breaks in the signal path through the ODN 108 result in a loss of signal and a service interruption to the customer. When signal is lost at an ONU 106, it is important to quickly and easily identify the source of the interruption in order to quickly and efficiently restore service connectivity. Systems, apparatuses and methods described herein allow for quick and easy identification of any source of interruption.

In an embodiment, a fiber Bragg grating (FBG) device 118 is deployed between the drop fiber 116, i.e., the ODN 108, and at least one of the ONUs 106, i.e., an edge or endpoint of the ODN 108. FBGs 118 generally include gratings formed from a series of refractive index perturbations along an optical fiber. The FBG 118 reflects light traveling in the forward direction in the core of the optical fiber backwards into the core. The reflected light includes less than the entire light profile emitted on the core of the optical fiber as described in greater detail below. The reflected light travels backwards through the core and can be sampled at a remote location, e.g., by a technician, to determine if an interruption exists along the optical fiber.

The FBG 118 can be built in a short segment of an optical fiber and periodically modulate a refractive index of the fiber core. When light propagates through the fiber core and interacts with the FBG 118, and the wavelength of the light, λ_{B}, satisfies the Bragg condition, i.e.,

$${λ}_{B} = 2 \times {n}_{e} \times Λ \qquad ( 1 )$$

the light will be reflected. Light whose wavelength does not meet the Bragg condition is passed through the FBG 118 with little or no perturbation. In Eq. (1), Λ represents the grating period, e.g., it is ˜0.5 μm for a 1550 nm FBG 118; nₑ is the effective refractive index of the fiber core, which is ˜1.47 for a typical single mode fiber operating at 1550 nm.

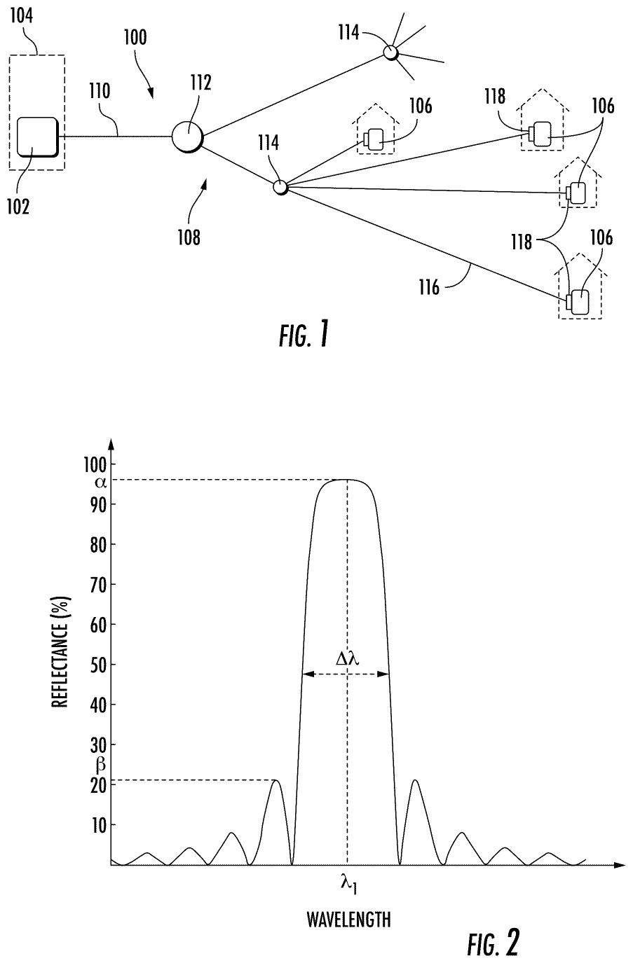

Referring to FIG. 2, the FBG 118 has a reflection waveband with a center Bragg wavelength 21 and a full width at half maximum (FWHM) bandwidth Δλ. The center Bragg wavelength 21 and bandwidth Δλ can be varied by controlling the structural and material properties of the FBG 118. For example, the period Λ and the refractive index modulation depth Δn can be controlled to vary the center Bragg wavelength and bandwidth. Within the reflection band, a desired reflectance α % can be obtained by controlling the total number of grating periods, i.e., the length of the grating. The FBG 118 can be selected to have a high reflectance, such as, e.g., at least 50%, such as at least 55%, such as at least 60%, such as at least 65%, such as at least 70%, such as at least 75%, such as at least 80%. However, outside the reflection band, such a high reflectance may inevitably introduce sidelobes which can induce unwanted back reflections in the transmission waveband. It is desirable to have the maximum reflectance within the transmission band as low as possible. A desired reflectance may be achieved through adjusting the FBG 118 structurally, e.g., using apodized grating structure.

In an embodiment, the reflection waveband does not interfere with the operational wavebands of the ODN 108. The common operation wavebands of a FTTH network range from 1260 nm to 1360 nm and 1480-1620 nm. The center Bragg wavelength of the FBG 118 can be selected outside these bands. A wavelength from 650 nm to 1040 nm, or a wavelength from 1390 nm to 1450 nm, or a longer wavelength beyond 1620 nm may be appropriate. For example, a wavelength of 1430 nm or 1650 nm may be appropriate. The desired reflection bandwidth may be selected according to the application requirements. Typically, it is set around ±5 nm, which may be wide enough to well compensate possible temperature-dependent wavelength shift of an optical test source and Bragg wavelength.

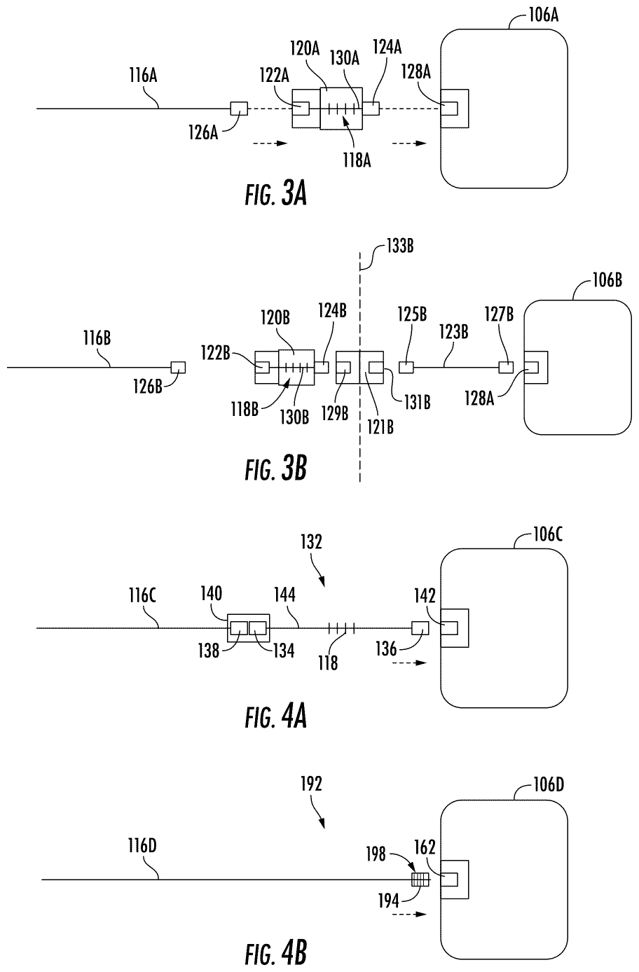

FIGS. 3A to 5 illustrate FBG devices 118 incorporated into various structures in accordance with exemplary embodiments of the present disclosure. These structures can be used alone or in combination to provide selective reflection of optical signals travelling in the ODN 108 to allow technicians to verify network connectivity. The structures can be coupled to the ODN 108 at its edges to allow for verification of connectivity to the edge of the ODN 108. It should be understood that the following embodiments are exemplary only and that the invention is not intended to be limited to these described embodiments.

FIG. 3A illustrates a socket-plug-type reflector 120A in accordance with an embodiment. The socket-plug-type reflector 120A can be formed from a discrete body which is removably coupled between a drop fiber 116A, i.e., an edge of the ODN 108, and the ONU 106A, i.e., an outside device not part of the ODN 108 that is coupled to the edge of the ODN 108. The socket-plug-type reflector 120A can include interfaces that allow it to be coupled relative to the drop fiber 116A and the ONU 106A. For example, the socket-plug-type reflector 120A can include a socket 122A and a plug 124A. The socket 122A can be configured to receive a plug 126A disposed on an end of the drop fiber 116A to optically couple the socket-plug-type reflector 120A to the drop fiber 116A. By way of non-limiting example, the socket 122A and plug 126A can be coupled through an SC connector interface, an LC connector interface, an ST connector interface, an FC connector interface, an MT-RJ connector interface, an MU connector interface, an MTP connector interface, an MPO connector interface, or the like. In an embodiment, the socket 122A and plug 126A can be inverted such that the socket 122A is disposed on the end of the drop fiber 116A and the plug 126A is disposed on the socket-plug-type reflector 120A. The plug 124A can interface with a socket 128A on the ONU 106A. As described above, and by way of non-limiting example, the socket 128A and the plug 124A can be coupled through an SC connector interface, an LC connector interface, an ST connector interface, an FC connector interface, an MT-RJ connector interface, an MU connector interface, an MTP connector interface, an MPO connector interface, or the like. Moreover, the socket 128A and the plug 124A can be inverted such that the socket 128A is disposed on the socket-plug-type reflector 120A and the plug 124A is disposed on the ONU 106A.

In an embodiment, the socket-plug-type reflector 120A can be coupled to the ONU 106A after the drop fiber 116A is coupled to the socket-plug-type reflector 120A. In another embodiment, the socket-plug-type reflector 120A can be coupled to the ONU 106A before the drop fiber 116A is coupled to the socket-plug-type reflector 120A. For example, the socket-plug-type reflector 120A can be coupled to the ONU 106A at the factory, i.e., prior to arriving at the customer's premises. In an embodiment, the socket-plug-type reflector 120A can be disposed within the interior of the ONU 106A. In this regard, the socket-plug-type reflector 120A can be part of the ONU 106A. In another embodiment, the socket-plug-type reflector 120A can be at least partially exposed from the body of the ONU 106A to allow for direct engagement of the plug 126A to the socket 122A. In yet other instances, the socket-plug-type reflector 120A can be separate from the ONU 106A. For instance, the socket-plug-type reflector 120A can include a discrete body (or bodies) which can be interposed between the drop fiber 116A and the ONU 106.

In certain instances, the drop fiber 116A can be pre-terminated, e.g., by a technician at a previous time, and include the socket-plug-type reflector 120A. In other instances, the drop fiber 116A can be coupled with one or more intermediary optical cables which transmit optical signals from the drop fiber 116A to a location within the customer's premises. In some instances, the intermediary optical cables can be pre-terminated to include the socket-plug-type reflector 120A. Using the pre-terminated drop fiber 116A or the intermediary optical cable, the customer can install the ONU 106A simply by moving the ONU 106A to the drop fiber 116A and installing the plug 124A to the socket 128A. The customer then powers the ONU 106A, e.g., using a separate power cord which is plugged into a power supply, such as an AC wall socket. At such time, the ONU 106A is optically coupled to the ODN 108.

If the customer loses network signal, the network provider can test the ODN 108 as described below to determine whether the interruption has occurred prior to the socket-plug-type reflector 120A, and more particularly, whether the interruption has occurred within the drop fiber 116A.

FIG. 3B illustrates a socket-plug-type reflection 120B in accordance with another embodiment. The socket-plug-type reflector 120B can be formed from a discrete body which is removably coupled between the drop fiber 116B, i.e., an edge of the ODN 108, and the ONU 106B, i.e., an outside device not part of the ODN 108 that is coupled to the edge of the ODN 108. The socket-plug-type reflector 120B can include interfaces for coupling relative to the drop fiber 116B and an adapter from inside a cable wall jack 121B. For example, the socket-plug-type reflector 120B can include a socket 122B and a plug 124B. The socket 122B can be configured to receive a plug 126B disposed on an end of the drop fiber 116B to optically couple the socket-plug-type reflector 120B to the drop fiber 116B. By way of non-limiting example, the socket 122B and plug 126B can be coupled through an SC connector interface, an LC connector interface, an ST connector interface, an FC connector interface, an MT-RJ connector interface, an MU connector interface, an MTP connector interface, an MPO connector interface, or the like. In an embodiment, the socket 122B and plug 126B can be inverted such that the socket 122B is disposed on the end of the drop fiber 116B and the plug 126B is disposed on the socket-plug-type reflector 120B. The plug 124B can interface with a socket 129B on the cable wall jack 121B. As described above, and by way of non-limiting example, the socket 129B and the plug 124B can be coupled through an SC connector interface, an LC connector interface, an ST connector interface, an FC connector interface, an MT-RJ connector interface, an MU connector interface, an MTP connector interface, an MPO connector interface, or the like. Moreover, the socket 129B and the plug 124B can be inverted such that the socket 129B is disposed on the socket-plug-type reflector 120B and the plug 124B is disposed on the cable wall jack 121B.

The cable wall jack 121B can be coupled to the ONU 106B through an intermediate cable 123B. The intermediate cable 123B can include plugs 125B and 127B (or sockets) which interface with sockets 131B and 128A (or plugs), respectively, on the cable wall jack 121B and ONU 106B. The cable wall jack 121B can be disposed in a wall 133B, a surface of a dwelling or building, an interface component, or the like.

In an embodiment, the socket-plug-type reflector 120B can be coupled to the cable wall jack 121B during an initial installation. For example, the plug 124B of the socket-plug-type reflector 120B can be coupled with the socket 129B of the cable wall jack 121B by an installation technician. This initial installation may occur prior to coupling of the drop fiber 116B at the location of the wall 133B. In some instances, coupling of the socket-plug-type reflector 120B to the cable wall jack 121B can be performed on site, i.e., in situ at the wall 133B. In other instances, coupling of the socket-plug-type reflector 120B to the cable wall jack 121B can occur at a remote location, e.g., at a manufacturing facility or prefab facility where components of the socket-plug-type reflector 120B or cable wall jack 121B are manufactured or assembled. In an embodiment, the socket-plug-type reflector 120B can be protected by the cable wall jack 121B. In other instances, the socket-plug-type reflector 120B may be exposed from the cable wall jack 121B.

In an embodiment, the drop fiber 116B can be coupled with the socket-plug-type reflector 120B at an approximately same time that the socket-plug-type reflector 120B is installed at the cable wall jack 121B. For example, the drop fiber 116B can be installed on the same day as the socket-plug-type reflector 120B. In other instances, the drop fiber 116B can be coupled with the socket-plug-type reflector 120B at a different time than the socket-plug-type reflector 120B being installed at the cable wall jack 121B. For example, the cable wall jack 121B may be installed during construction of a dwelling or office building. The socket-plug-type reflector 120B may be installed simultaneously, or at a later date. The drop fiber 116B may not be installed at the same time as the cable wall jack 121B or the socket-plug-type reflector 120B. In this regard, the socket-plug-type reflector 120B may be disconnected from the ODN 108 for a period of time, e.g., days, weeks or months, prior to receiving the drop fiber 116B. During such time, testing of the drop fiber 116B as described below would indicate that the drop fiber 116B is not yet coupled to the socket-plug-type reflector 120B, let alone the outside device, e.g., the ONU 106B. After the drop fiber 116B is installed at the socket-plug-type reflector 120B, testing of the drop fiber 116B as described below would indicate that the drop fiber 116B is coupled to the socket-plug-type reflector 120B.

Use of the socket-plug-type reflector 120B can allow for easy switching between different socket-plug-type reflectors 120B. For example, if there is a defect to the socket-plug-type reflector 120B, the service provider can send the customer a replacement socket-plug-type connector 120B and instruct the customer on proper installation of the socket-plug-type connector 120B. Moreover, the socket-plug-type reflector 120B may be readily swappable if a different ONU 106 is used or if the reflection waveband of the socket-plug-type reflector 120 is changed.

The socket-plug-type reflector 120B can house the FBG 118. The FBG 118 can be disposed along, or coupled within, an internal optical fiber 130 which extends between the socket 122B and the plug 124B. In one or more embodiments, the FBG 118 can be removably coupled to the socket-plug-type reflector 120B. In another embodiment, the FBG 118 can be non-removably integrated into the socket-plug-type reflector 120B.

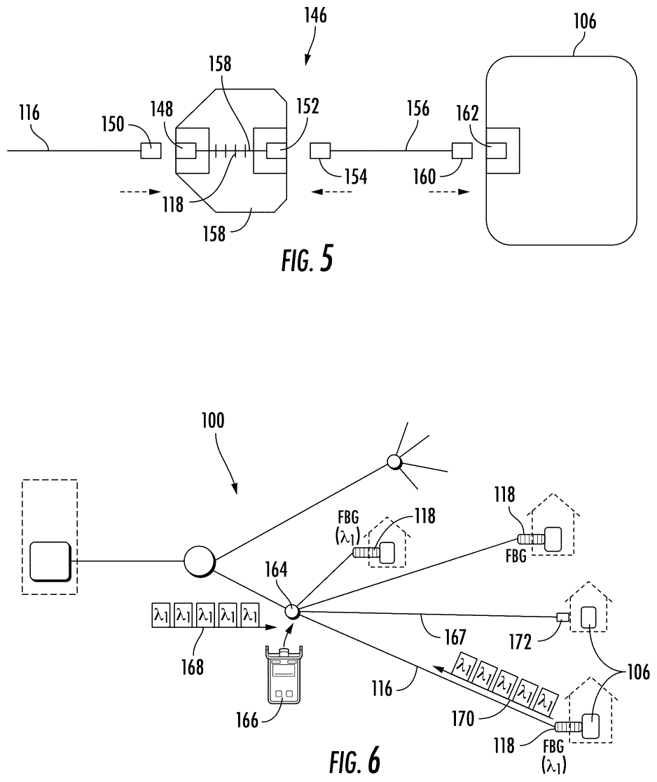

FIG. 4A illustrates a cable-type reflector 132 in accordance with an embodiment. Similar to the socket-plug-type reflector 120A depicted in FIG. 3A, the cable-type reflector 132 can bridge the drop fiber 116C, i.e., an edge of the ODN 108, and the ONU 106C, i.e., an outside device not part of the ODN 108 that is coupled to the edge of the ODN 108. By way of non-limiting example, the cable-type reflector 132 can include a first plug 134 on an end to be coupled to the drop fiber 116C and a second plug 136 on an end to be coupled to the ONU 106C. The plug 134 can be coupled to a plug 138 on an end of the drop fiber 116C by way of an adapter 140. The plugs 134 and 138 can be interfaced through an SC connector interface, an LC connector interface, an ST connector interface, an FC connector interface, an MT-RJ connector interface, an MU connector interface, an MTP connector interface, an MPO connector interface, or the like. The plug 136 can be interfaced with a socket 142 on the ONU 106C. In an embodiment, the adapter 140 can be a part of a cable wall jack 121B similar to the one depicted in FIG. 3B. The plug 136 and socket 142 can be interfaced through an SC connector interface, an LC connector interface, an ST connector interface, an FC connector interface, an MT-RJ connector interface, an MU connector interface, an MTP connector interface, an MPO connector interface, or the like. In an embodiment, any one of the plugs 134, 136 or 138 or socket 142 can be inverted to include the opposite of the plug- or socket-type connection interface. For example, by way of non-limiting example, the plug 136 can be a socket and the socket 142 can be a plug. Similarly, the plugs 134 and 138 can instead be engaged to one another directly by a plug-to-socket interface whereby, e.g., the plug 134 is instead a socket which receives the plug 138 or the plug 138 is a socket which receives the plug 134. Yet other embodiments are contemplated herein without deviating from the scope of the disclosure.

In an embodiment, the cable-type reflector 132 can be housed within an enclosure. However, in certain instances, the cable-type reflector 132 is not housed within an enclosure. Instead, the cable-type reflector 132 forms a freely accessible cable which can be manipulated by an operator, e.g., the customer. For example, the cable-type reflector 132 can include an optical cable 144 which extends between the adapter 140 and the plug 136 and which can be directly grasped by an operator to install the cable-type reflector 132 to the ONU 106C. The FBG 118 can be disposed along the cable 144. In some instances, the FBG 118 can be disposed within the cable 144 such that the FBG 118 is not detectable by the customer. In other instances, the FBG 118 can be disposed within an enclosure, e.g., a housing, which is coupled to the cable 144 at a location between the plugs 134 and 136.

In some instances, the plug 138 at the end of the drop fiber 116C may be disposed at a location which makes it difficult to maneuver the drop fiber 116C so as to attach to the ONU 106C. For instance, an exposed length of the drop fiber 116C which is accessible may be too short to allow an operator to easily manipulate the placement of the plug 138. In this regard, the location of the ONU 106C may be restricted to a small area or require inclusion of a spliced fiber to extend the exposed length of the drop fiber 116. Use of the cable-type reflector 132 can effectively increase the length of the drop fiber 116C, thereby mitigating this situation. In some instances, the length of the cable-type reflector 132, as measured between the plugs 134 and 136, can be at least 1 inch, such as at least 2 inches, such as at least 3 inches, such as at least 4 inches, such as at least 5 inches, such as at least 6 inches, such as at least 12 inches. In another embodiment, the length of the cable-type reflector 132 can be no greater than 72 inches, such as no greater than 60 inches, such as no greater than 48 inches, such as no greater than 36 inches, such as no greater than 24 inches, such as no greater than 12 inches.

FIG. 4B illustrates a cable-type reflector 192 in accordance with another embodiment. The cable-type reflector 192 can bridge the drop fiber 116D and the ONU 106D. The cable-type reflector 192 can include a plug 194 (or socket) configured to interface with a socket 196 (or plug) of the ONU 106D. The cable-type reflector 192 can include an FBG grating 198. In some instances, the FBG grating 198 can be a pigtailed connector spliced with the drop fiber 116D. In other instances, the plug 194 with the FBG grating 198 can be a field-installable connector free of splicing.

FIG. 5 illustrates a cassette-type reflector 146. The cassette-type reflector 146 can include similar elements as compared to both the socket-plug-type reflector 120 depicted in FIG. 3A and the cable-style reflector 132 depicted in FIG. 4A. For example, the cassette-type reflector 146 can include a body 158 defining a first socket 148 configured to receive a plug 150 of the drop fiber 116 and a second socket 152 configured to receive a plug 154 of a cable 156. By way of non-limiting example, the plug 150 and socket 148 can be interfaced through an SC connector interface, an LC connector interface, an ST connector interface, an FC connector interface, an MT-RJ connector interface, an MU connector interface, an MTP connector interface, an MPO connector interface, or the like. Similarly, the plug 154 and socket 152 can be interfaced through an SC connector interface, an LC connector interface, an ST connector interface, an FC connector interface, an MT-RJ connector interface, an MU connector interface, an MTP connector interface, an MPO connector interface, or the like. In an embodiment, either or both of the plugs 150 or 154 and sockets 148 or 152 can be inverted to the other of a socket or plug.

The cable 156 can extend from the body 158 to the ONU 106 and engage with the ONU 106 through a plug 160 which couples with a socket 162 of the ONU 106. The plug 160 and socket 162 can be interfaced through an SC connector interface, an LC connector interface, an ST connector interface, an FC connector interface, an MT-RJ connector interface, an MU connector interface, an MTP connector interface, an MPO connector interface, or the like. In an embodiment, the plug 160 and socket 162 can be inverted such that the plug 160 is a socket and the socket 162 is a plug.

The body 158 of the cassette-type reflector 146 can receive the FBG 118, protecting the FBG 118 without requiring that the body 158 be coupled directly to the ONU 106. The cable 156 can couple the body 158 to the ONU 106, such that the operator has slack to work with when routing the drop fiber 116 and cassette-type reflector 146 to the ONU 106. Similar to the socket-plug-type reflector 120, the cassette-type reflector 146 can allow the service provider to readily swap between different bodies 158 to fix defects to the FBG 118 without requiring a technician onsite.

The reflectors 120A, 120B, 132, 146 and 192 described above allow a network service provider to readily check the ODN 108 for interruptions that might impact use of the ODN 108. By positioning the reflectors 120A, 120B, 132, 146 and 192 at, or near, edges of the ODN 108, the network service provider can determine if the interruption in signal is contained within the ODN 108 or outside of the ODN 108. For example, an interruption along the drop fiber would be detectable by the lack of reflected signal from the FBG 118, whereas an interruption at the customer's premises (e.g., the ONU is not properly connected or lost power) would not result in a loss of reflected signal from the FBG 118.

An exemplary process of network connection verification will now be described. Referring to FIG. 6, a service personnel can utilize an access point location 164 (often referred to as a demarcation point) on the PON 100 to verify network connectivity. The access point location 164 can correspond with an accessible area of the PON 100. For example, in a particular instance the access point location 164 can include a field enclosure, an access terminal, or another suitable location. In an embodiment, the access point location 164 is easy to access at ground level. The access point location 164 can serve as an access point for a plurality of premises or dwellings. The service personnel can verify each of the plurality of premises or dwellings utilizing the same access point location 164. For example, the access point location 164 can be disposed upstream of a plurality of dwellings. The term upstream generally refers to a location closer to the ODN 108 or within the ODN 108. The service personnel can successively verify network connectivity to one or more of the plurality of downstream dwellings.

The service personnel can utilize a tester 166 to verify network connectivity. The tester 166 is configured to inject an optical test signal 168 into the drop fiber 116 (or an associated fiber in communication with the drop fiber 116). The optical test signal 168 can have a wavelength that matches the Bragg wavelength λ₁ of the FBG 118 installed on the end of the drop fiber 116 at the customer's premise. In an embodiment, the optical test signal 168 can be a continuous wave (CW) signal. In another embodiment, the optical test signal 168 can be a pulsed signal. In another embodiment, the optical test signal 168 can be a modulated signal, such as the square wave shown in FIG. 6. In yet another embodiment, another suitable optical test signal 168 can be employed. The optical test signal 168 can travel through the drop fiber 116 to the FBG 118. The test signal 168 is reflected off the FBG 118 and travels back through the drop fiber 116 to be detected, e.g., by the tester 166, as backreflected test light 170. The backreflected test light 170 has a known characteristic which is indicative of presence of the FBG 118 at the end of the drop fiber 116.

By detecting the backreflected test light 170 and analyzing the signal characteristics such as the intensity/power, modulation frequency, etc., the tester 166 (or another associated piece of equipment) can detect the presence of the installed FBG 118 and verify connectivity of the drop fiber 116 to the customer's premises.

In an embodiment, the FBG 118 can have a high reflectance, e.g., 80%, which is significantly higher than the reflectance of any untargeted backscattering/specular reflections within the fiber path. High reflectance can mitigate noise and reduce the chance of the tester 166 incorrectly determining network connectivity.

In certain instances, the access point location 164 can send the optical test signal 168 to a plurality of premises, e.g., each associated with a different customer. Not all of the premises need to have the FBG 118 installed. For example, drop cable 167 is not associated with an FBG 118. Instead, the drop cable 167 is terminated with a connector 172. The connector 172 may introduce a relatively small amount of backreflection into the drop cable 167 as compared to backreflection caused by the FBG 118. Such a distinguishable signal level difference may help reliably identify the installed FBG 118 versus the uninstalled drop cable 167. In an embodiment, the verification process can be repeated several times to verify connection of each of the FBG 118.

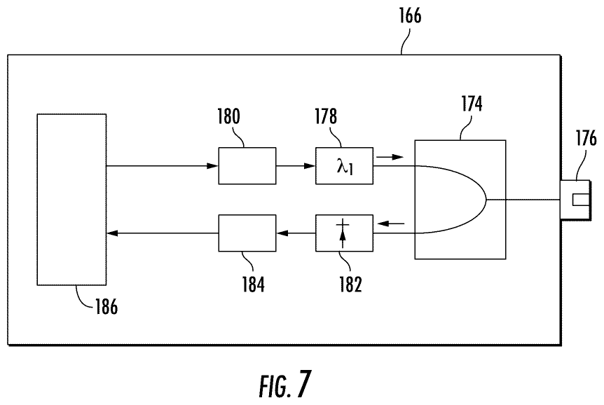

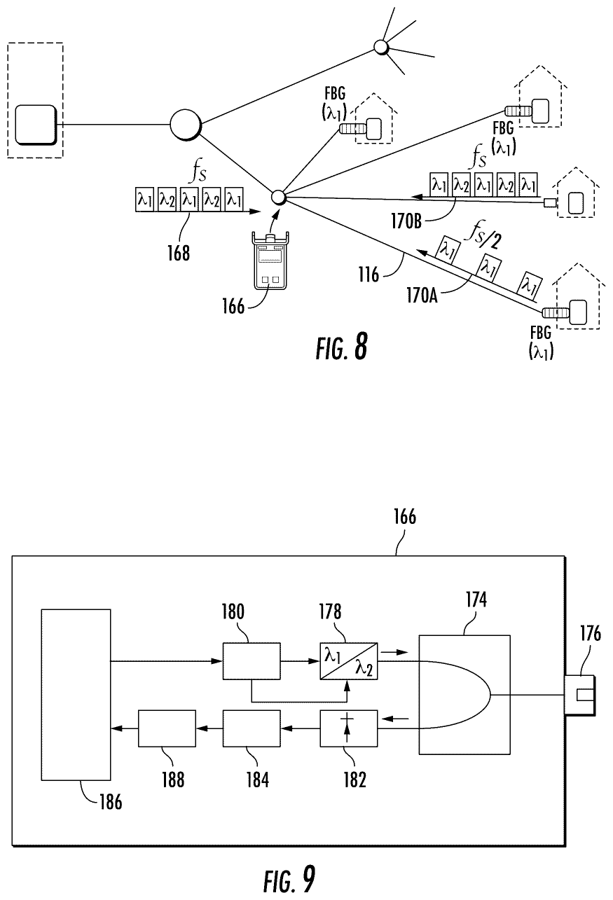

FIG. 7 illustrates an exemplary schematic diagram of the tester 166 in accordance with an embodiment. The tester 166 includes an optical branching device 174, such as a coupler or a circulator, which branches the emitted and received light paths to a test port 176. The test port 176 is connected to the PON 100 at the access point location 164. In some instances, the test port 176 may be directly connected to the access point location 164. For example, the access point location 164 can have a pre-terminated connector which interfaces with the test port 176. In other instances, the test port 176 can be connected to the access point location 164 through an intermediary cable, such as a jumper cable. A light source 178 driven by a driving circuit 180 can emit the optical test signal at a Bragg wavelength λ₁ to the test port 176. The optical test signal can then travel through the access point location 164 to the FBG 118 for verification. By way of non-limiting example, the light source 178 can be a laser diode, a light emitting diode (LED), or the like. A photodiode 182 combined, e.g., with a transimpedance amplifier 184 can receive backreflected test light 170 from the drop fiber 116 and convert the light into an electronic signal. A microcontroller 186, e.g., with on-chip ADC, DAC, timers, or the like, generates control waveforms and drives the light source 178, meanwhile the microcontroller 186 measures signal properties of received backreflected test light 170, such as its optical power, modulation frequency, or the like. Based on these measured signal properties, e.g., a uniquely high power level by Bragg reflections, an algorithm executed by the microcontroller 186 (or another processing unit) running software stored on a memory device can determine whether the FBG 118 is installed or not. In certain instances, this determination can be performed by comparing the output of the algorithm relative to known, or expected, values. By presetting and knowing the power level of the emitted optical testing signal 168, the optical insertion loss of the drop fiber 116 between the access point location 164 and the ONU 106 can be measured. The length of the drop fibers 116 can also be measured by measuring the time-of-flight of a pulse of the optical testing signal 168 reflected by the FBG 118. The same detection and measurement capabilities can also be implemented using other digital/analog circuitries such as field programmable gate arrays (FPGA), or the like.

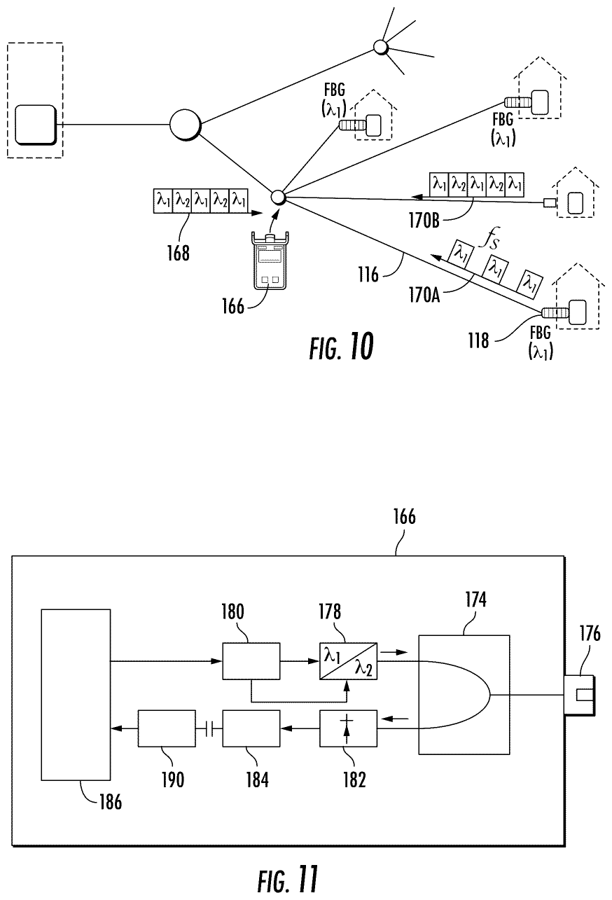

Another embodiment of a method of verification using the tester 166 is shown in FIGS. 8 and 9. The tester 166 depicted in FIGS. 8 and 9 can suppress or eliminate unwanted backreflection test light 170 from non-FBG sources. Similar to the embodiment depicted in FIGS. 6 and 7, the tester 166 can emit an optical test signal 168 into the drop fiber 116 under-test. The optical test signal 168 can include a modulated optical test signal, e.g., a square wave with a modulation frequency of fₛ. The square wave light is coded, e.g., color coded, by interleaving lights of different wavelengths, such as two different wavelengths. By way of non-limiting example, the wavelengths can include a first wavelength λ₁ and a second wavelength λ₂. Wavelength λ₁ matches the Bragg frequency of an installed FBG 118, e.g., 1430 nm. The other wavelength λ₂ is selected outside the Bragg reflection waveband, e.g., 1550 nm. When the modulated testing signal 168 interacts with the FBG 118, only the λ₁ component of the modulated testing signal 168 is backreflected. Thus, the frequency of the backreflected test light 170A from the FBG 118 coupled to the drop fiber 116 under-test is half of fₛ while the frequency of the backreflected test light 170B from other unwanted backreflection sources, such as an air-glass interface within the fiber, maintain the same frequency of the test light fₛ.

To achieve the multi-wavelength emission into the drop fiber 116 under-test, the tester 116 can include a dual-wavelength light source 178 and multi-wavelength driving circuits 180 can be included in the tester 166. A low pass filter (LPF) 188 can be included in the light detection circuitry, whose cutoff frequency is <fₛ, to filter out the signal components with frequency fₛ. The signal component with frequency fₛ/2 can thus be measured exclusively. This dual-wavelength detection approach can effectively suppress unwanted backreflection noise and is insensitive to optical power level variations due to varied fiber losses or fiber defects. The LPF 188 can be implemented digitally in the microcontroller 186, such as through software code or in electronic hardware (such as an FPGA).

Another embodiment of a method of verification using the tester 166 is shown in FIGS. 10 and 11. The tester 166 depicted in FIGS. 10 and 11 can suppress or eliminate unwanted backreflection test light 170 from non-FBG sources. Similar to the embodiment depicted in FIGS. 8 and 9, the tester 166 can emit a continuous testing signal 168 into the drop fiber 116 under-test. The continuous testing signal 168 is continuously emitted while its wavelength is alternated between the two or more wavelengths, e.g., a first wavelength λ₁ and a second wavelength λ₂. The switching rate between the first and second wavelengths can be set at a frequency of fₛ. Thus, the backreflected test light 170A from an installed FBG 118 becomes a square wave signal with a frequency of fₛ, while unwanted specular reflection signal 170B, i.e., from non-FBG sources, presents as a DC signal and can be rejected by an AC coupled bandpass filter (BPF) 190 as shown in FIG. 11. The center frequency of BPF 190 can be set at fₛ, and the bandwidth can be set as narrow as desired to pick up possibly weak FBG signal. The BPF 190 can also be implemented digitally in microcontroller 186, such as through software code or electronic hardware.

The described methods and apparatuses in accordance with the present disclosure can advantageously and effectively detect and verify connectivity from a test access point to a network edge. By detecting continuity between the test access point and the network edge, it is easier to solve network interruption issues.

While the described embodiments are for a passive optical network, it should be understood that the same systems and methods can be used with other types of optical networks. For example, the reflectors 120A, 120B, 132, 146 and 192 and related systems and methods can be used in any core network that serves another (secondary) network. The secondary network can include a wireless network (e.g., having antennas for wireless transmission), a secondary service provider network, or a business customer's network or access connection. These secondary networks are not part of the core network associated with the ODN 108 and may be outside of the core network service provider's access. So, for example, if the operator of the secondary network (e.g., a business customer) complains about loss of service, the core network service provider can verify connectivity and insertion loss to the FBG placed at the edge of the core network. If connectivity to the edge of the core network is verified, then the core network service provider knows that the issue lies outside of their network. This can save time in troubleshooting and allow for remote inspection without requiring an operator to walk or inspect every foot of fiber optic line.

In an embodiment, the secondary network can include an FBG at an edge of the secondary network. In some instances, the core network provider can access the secondary network and detect whether the secondary FBG is connected to the core network. The FBG at the secondary network can be configured to reflect a different wavelength λ₂ than the first wavelength λ₁ of the ODN 108. Optical signals passing to the FBG of the secondary network are not reflected by the FBG of the core network. Instead, the optical signals that are reflected by the FBG of the secondary network pass through the FBG of the core network in both the output and reflected directions. The core network service provider can thus determine whether the secondary network is coupled to the core network.

Further aspects of the invention are provided by one or more of the following embodiments:
Embodiment 1. A method for verifying network continuity, the method comprising: providing a fiber Bragg grating (FBG) device at a cable associated with a network, wherein the FBG device is configured to reflect a λ wavelength; sending an optical test signal into the cable from a location upstream of the FBG device, the optical test signal having a λ₁ wavelength; and detecting a reflected signal associated with the λ₁ wavelength to verify network connectivity to the FBG device and measure network insertion loss.
Embodiment 2. The method of any one or more of the embodiments, wherein the FBG device is disposed at an edge of the network.
Embodiment 3. The method of any one or more of the embodiments, wherein the edge of the network is a customer premise.
Embodiment 4. The method of any one or more of the embodiments, wherein the FBG is provided at the cable prior to an optical network unit (ONU) being installed at the customer premise.
Embodiment 5. The network of any one or more of the embodiments, wherein the edge of the network is configured to be coupled with a secondary network comprising a different type of network as compared to the network.
Embodiment 6. The method of any one or more of the embodiments, wherein providing the FBG device at the cable is performed by an installation technician by installing the FBG device adjacent to an end of the cable, wherein the network is configured to be coupled with a secondary network, and wherein coupling the secondary network to the network is performed after providing the FBG device at the cable.
Embodiment 7. The method of any one or more of the embodiments, further comprising measuring cable length in response to time-of-flight of the optical test signal as measured between sending the optical test signal and detecting the reflected signal.
Embodiment 8. The method of any one or more of the embodiments, wherein sending the optical test signal and detecting the reflected signal is performed by a single device disposed upstream of the FBG device.
Embodiment 9. The method of any one or more of the embodiments, wherein the optical test signal comprises a square wave with a modulation frequency of fₛ, and wherein light detecting circuitry detecting the reflected signal comprises a low pass filter (LPF) with a cutoff frequency less than fₛ.
Embodiment 10. The method of any one or more of the embodiments, wherein the optical test signal is continuously emitted onto the drop fiber, wherein the optical test signal is alternated between at least two different wavelengths at a frequency Fₛ, and wherein a bandpass filter (BPF) is set at Fₛ.
Embodiment 11. The method of any one or more of the embodiments, wherein the FBG device comprises an apodized grating structure.
Embodiment 12. The method of any one or more of the embodiments, wherein providing the FBG device at a cable associated with a network comprises providing one or more FBG devices at each of a plurality of different cables associated with an edge of the network, wherein sending the optical test signal into the cable is performed at a demarcation point of the network, wherein the demarcation point is disposed between a service provider central office and an edge of the network, wherein the demarcation point comprises a splitter distributing a signal from the service provider central office to each of the plurality of different cables, and wherein sending the optical test signal is performed individually for each of the plurality of different cables.
Embodiment 13. The method of any one or more of the embodiments, wherein the FBG device comprises a first FBG device, wherein the optical test signal passes through a second FBG device before encountering the first FBG device, the second FBG device configured to reflect a λ₂ wavelength different from the λ₁ wavelength.
Embodiment 14. An optical network architecture for verifying network continuity, the optical network architecture comprising: a service provider central office that sends optical signals through a network; a plurality of cables associated with endpoints of the network; an optical fiber network optically coupling the service provider central office to the plurality of cables, wherein the optical fiber network comprises a splitter; and a plurality of fiber Bragg grating (FBG) devices each optically coupled to one of the plurality of cables.
Embodiment 15. The optical network architecture of any one or more of the embodiments, wherein each of the plurality of FBG devices is configured to reflect a λ₁ wavelength, and wherein the λ₁ wavelength is an optical test signal injected into the optical fiber network from a demarcation point associated with the splitter.
Embodiment 16. The optical network architecture of any one or more of the embodiments, wherein the optical test signal is injected into the optical fiber network from a single device disposed upstream of the FBG device, wherein the single device is configured to separately send the optical test signal into each of the plurality of cables and detect a reflected signal reflected from the FBG device associated with that cable.
Embodiment 17. The optical network architecture of any one or more of the embodiments, wherein the single device is configured to determine an insertion loss of the optical test signal.
Embodiment 18. The optical network architecture of any one or more of the embodiments, wherein the λ₁ wavelength is 1430 nm or 1650 nm, or other suitable wavelength(s).
Embodiment 19. The optical network architecture of any one or more of the embodiments, wherein at least one of the FBG devices comprises a socket-plug-type reflector, a cassette-type reflector, or a cable-type reflector.
Embodiment 20. The optical network architecture of any one or more of the embodiments, wherein the plurality of cables are drop cables.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for verifying network continuity, the method comprising:
providing a fiber Bragg grating (FBG) device at a cable associated with a network, wherein the FBG device is configured to reflect a λ₁ wavelength;
sending an optical test signal into the cable from a location upstream of the FBG device, the optical test signal having a λ₁ wavelength; and
detecting a reflected signal associated with the λ₁ wavelength to verify network connectivity to the FBG device and measure network insertion loss.

2. The method of claim 1, wherein the FBG device is disposed at an edge of the network.

3. The method of claim 2, wherein the edge of the network is a customer premise.

4. The method of claim 3, wherein the FBG is provided at the cable prior to an optical network unit (ONU) being installed at the customer premise.

5. The network of claim 2, wherein the edge of the network is configured to be coupled with a secondary network comprising a different type of network as compared to the network.

6. The method of claim 1, wherein providing the FBG device at the cable is performed by an installation technician by installing the FBG device adjacent to an end of the cable, wherein the network is configured to be coupled with a secondary network, and wherein coupling the secondary network to the network is performed after providing the FBG device at the cable.

7. The method of claim 1, further comprising measuring cable length in response to time-of-flight of the optical test signal as measured between sending the optical test signal and detecting the reflected signal.

8. The method of claim 1, wherein sending the optical test signal and detecting the reflected signal is performed by a single device disposed upstream of the FBG device.

9. The method of claim 1, wherein the optical test signal comprises a square wave with a modulation frequency of fₛ, and wherein light detecting circuitry detecting the reflected signal comprises a low pass filter (LPF) with a cutoff frequency less than fₛ.

10. The method of claim 1, wherein the optical test signal is continuously emitted onto the drop fiber, wherein the optical test signal is alternated between at least two different wavelengths at a frequency Fs, and wherein a bandpass filter (BPF) is set at Fs.

11. The method of claim 1, wherein the FBG device comprises an apodized grating structure.

12. The method of claim 1, wherein providing the FBG device at a cable associated with a network comprises providing one or more FBG devices at each of a plurality of different cables associated with an edge of the network, wherein sending the optical test signal into the cable is performed at a demarcation point of the network, wherein the demarcation point is disposed between a service provider central office and an edge of the network, wherein the demarcation point comprises a splitter distributing a signal from the service provider central office to each of the plurality of different cables, and wherein sending the optical test signal is performed individually for each of the plurality of different cables.

13. The method of claim 1, wherein the FBG device comprises a first FBG device, wherein the optical test signal passes through a second FBG device before encountering the first FBG device, the second FBG device configured to reflect a λ₂ wavelength different from the λ₁ wavelength.

14. An optical network architecture for verifying network continuity, the optical network architecture comprising:
a service provider central office that sends optical signals through a network;
a plurality of cables associated with endpoints of the network;
an optical fiber network optically coupling the service provider central office to the plurality of cables, wherein the optical fiber network comprises a splitter; and
a plurality of fiber Bragg grating (FBG) devices each optically coupled to one of the plurality of cables.

15. The optical network architecture of claim 14, wherein each of the plurality of FBG devices is configured to reflect a λ₁ wavelength, and wherein the λ₁ wavelength is an optical test signal injected into the optical fiber network from a demarcation point associated with the splitter.

16. The optical network architecture of claim 15, wherein the optical test signal is injected into the optical fiber network from a single device disposed upstream of the FBG device, wherein the single device is configured to separately send the optical test signal into each of the plurality of cables and detect a reflected signal reflected from the FBG device associated with that cable.

17. The optical network architecture of claim 16, wherein the single device is configured to determine an insertion loss of the optical test signal.

18. The optical network architecture of claim 15, wherein the λ₁ wavelength is 1430 nm or 1650 nm, or other suitable wavelength(s).

19. The optical network architecture of claim 14, wherein at least one of the FBG devices comprises a socket-plug-type reflector, a cassette-type reflector, or a cable-type reflector.

20. The optical network architecture of claim 14, wherein the plurality of cables are drop cables
